(19) United States
(12) Patent Application Publication
(10) Pub. No.: US 2025/0390363 A1
(43) Pub. Date: Dec. 25, 2025

(54) SYSTEMS AND METHODS FOR MESSAGE-BASED DATA RETRIEVAL

(71) Applicant: Wells Fargo BAnk, N.A., San Francisco, CA (US)

(72) Inventors: Ram Gopal, Dublin, CA (US); Peter Rozovski, Concord, CA (US); Reni Thekkevilakathu, Concord, NC (US); Mandar Nandkumar Shasane, Phoenix, AZ (US); Abhijit Nandan Kumar, Phoenix, AZ (US)

(21) Appl. No.: 18/751,601

(22) Filed: Jun. 24, 2024

(51) Int. Cl. G06F 9/54; G06F 9/46; G06Q 20/10

(52) U.S. Cl. CPC G06F 9/542; G06F 9/466; G06Q 20/102

(57) ABSTRACT

A method may include detecting a scheduled transaction change for a future event with respect to a user account, the user account associated with a user account identifier; generating an electronic message according to a schema of a message streaming system, the electronic message include a topic identifier and the user account identifier; publishing the electronic message to the message streaming system; processing the electronic message from the message streaming system, wherein processing includes: parsing a payload of the electronic message to retrieve the user account identifier; accessing transaction details of the scheduled transaction change for the future event; and storing the transaction details in a staging database; in response to receiving a request to update an analysis of the user account, generating an analysis of a future state of the user account based in part on the data in the staging database; and storing the analysis.

### BACKGROUND

In the realm of online services, users often interact with platforms that allow them to plan and manage a series of transactions. These transactions may encompass a wide range of activities, including but not limited to, purchasing goods, booking travel arrangements, scheduling appointments, and organizing events. The online service may further allow the flexibility to modify these plans as needed.

### BRIEF DESCRIPTION OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Like numerals having different letter suffixes may represent different instances of similar components. Some embodiments are illustrated by way of example, and not limitation, in the figures of the accompanying drawing.

FIG. 1 is a block diagram of components of a client device and an application server according to various examples.

FIG. 2 is a block diagram of a message production and consumption architecture system, according to various examples.

FIG. 3 is a block diagram of operations in an event-oriented architecture, according to various examples.

FIG. 4 is a block diagram illustrating a machine in the example form of computer system 400, within which a set or sequence of instructions may be executed to cause the machine to perform any one of the methodologies discussed herein, according to various examples.

### DETAILED DESCRIPTION

The following description outlines specific examples to provide a thorough understanding of various inventive aspects. It will be evident, however, to one skilled in the art that the present invention may be practiced without these specific details. References in the specification to “one example,” “an example,” “an illustrative example,” etc., indicate that the example described may include a particular feature, structure, etc. Still, every example may not necessarily include that particular feature. Additionally, such phrases do not imply a single example, and the features may be incorporated into other examples described. It may be appreciated that lists in the form of “at least one A, B, and C” may mean (A); (B); (C): (A and B); (B and C); or (A, B, and C). Similarly, items listed in the form of “at least one of A, B, or C” can mean (A); (B); (C): (A and B); (B and C); or (A, B, and C). Furthermore, using such phrases does not negate the possibility of other options (e.g., (D)).

Throughout this disclosure, components may perform electronic actions in response to different variable values (e.g., thresholds, user preferences, etc.). As a matter of convenience, this disclosure does not always detail where the variables are stored or how they are retrieved. In such instances, it may be assumed that the variables are stored on a storage device (e.g., Random Access Memory (RAM), cache, hard drive) accessible by the component via an Application Programming Interface (API) or other program communication method. Similarly, the variables may be assumed to have default values should a specific value not be described. End-users or administrators may use user interfaces to edit the variable values.

In various examples described herein, user interfaces are described as being presented to a computing device. The presentation may include data transmitted (e.g., a hypertext markup language file) from a first device (such as a web server) to the computing device for rendering on a display device of the computing device via a web browser. Presenting may separately (or in addition to the previous data transmission) include an application (e.g., a stand-alone application) on the computing device generating and rendering the user interface on a display device of the computing device without receiving data from a server.

Furthermore, the user interfaces are often described as having different portions or elements. Although in some examples, these portions may be displayed on a screen simultaneously, in others, the portions/elements may be displayed on separate screens such that not all portions/elements are displayed simultaneously. Unless explicitly indicated as such, the use of “presenting a user interface” does not infer either one of these options.

Additionally, the elements and portions are sometimes described as being configured for a particular purpose. For example, an input element may be configured to receive an input string, a selection from a menu, a checkbox, etc. In this context, “configured to” may mean presenting a user interface element capable of receiving user input. “Configured to” may additionally mean computer executable code processes interactions with the element/portion based on an event handler. Thus, a “search” button element may be configured to pass text received in the input element to a search routine that formats and executes a structured query language (SQL) query to a database.

In data management systems, such as those handling scheduled transactions and user data, challenges arise related to efficiency (of computing resources) and timeliness. For example, consider that a user logs into a website, which triggers a call to analyze the user's account and provide the analysis results. One approach would be to trigger real-time API calls to fetch the latest data from a database and analyze the results. This approach introduces several inefficiencies due to potential system lag from the latency of API calls and places a heavy load on the system infrastructure. Furthermore, API calls may sometimes be made when the underlying data has not changed; thus, no new analysis is needed. Again, this wastes computing resources and slows down other higher-priority requests to data stores.

Another approach is a nightly batch processing of all user accounts. For example, API calls may made for each user account to retrieve account data. Then, the data analysis may be performed for each account. This process involves running extensive computational tasks overnight, regardless of whether there have been any changes to the users' transactions. This results in wasted computational resources and leads to unnecessary energy consumption, contributing to increased operational costs and environmental impact. The inefficiency is particularly pronounced when the batch processing reveals no changes have occurred.

Given the above problems with existing approaches, described herein is an Event-Oriented Architecture (EOA). The EOA uses a message streaming system (e.g., APACHE KAFKA®) to manage when API calls should be made to databases to retrieve transaction data for future analysis. A message in the EOA may replace an API call if the message includes all required information, which previously was received from API call response. For example, each change, such as updates to scheduled transactions or user events—triggers an event. These events are then formatted as messages and published with an identification of a specific topic.

A data aggregator may subscribe (e.g., be a consumer) to the topic and process messages from the message streaming system. The processing may include retrieving the details associated with the change and storing them in a database. Accordingly, when an analysis update is requested—either from a login or daily batch—there is no need for API calls to be made. Additionally, if a message has not been received from a message streaming system associated with a user account, no new data analysis may be needed. Even when a new analysis is needed, the responsiveness of the analysis is improved because the data is already present in the database.

This event-driven approach offers technical advantages over the prior methods. For example, it reduces the operational load on systems by decreasing the number of API calls—thereby preventing performance bottlenecks during peak usage times. Moreover, it removes the need for nightly batch processing of accounts when no changes have occurred, saving energy and reducing operational costs. The EOA allows for scalability as the system handles data changes incrementally and efficiently without the need for unnecessary re-processing of data. Furthermore, the responsiveness of user interfaces is improved due to the reduction in API calls.

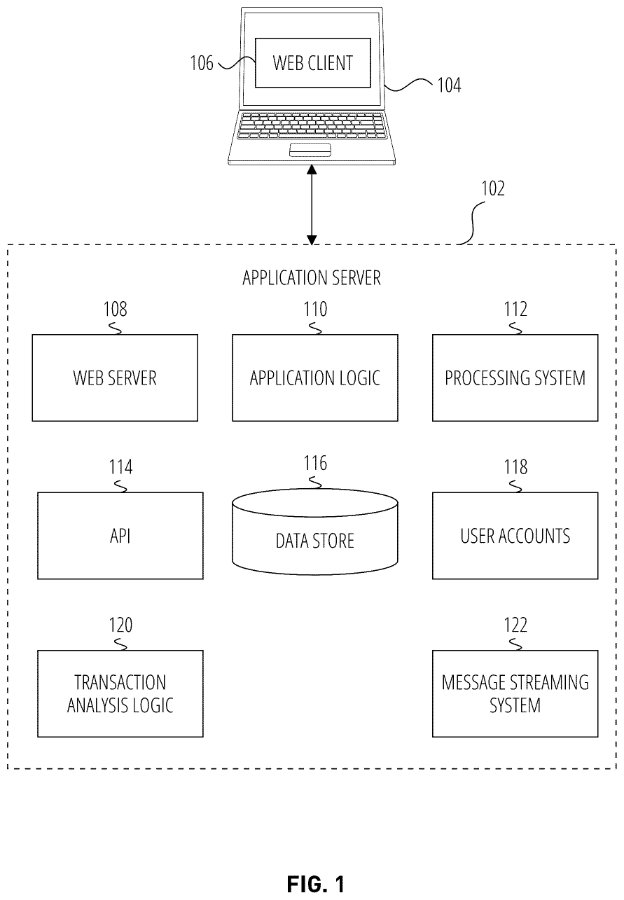

FIG. 1 is an example block diagram of components of a client device and an application server according to various examples. The application server 102 may be a server that provides services over a network to users. For example, the application server 102 may be a calendar service, a financial service, a game service, a media service, etc. The client device 104 may interact with the application server 102 using a webpage or app downloaded onto the client device 104.

As a running example operating environment, the application server 102 may provide financial services to users. The financial services may include a bill pay service that permits automatic payments from a payor account (e.g., a checking account) to a payee (e.g., a utility company). The bill pay service enables users to set up recurring payments for various expenses such as utility bills, credit card payments, or subscription services. Users can specify the amount, frequency, and duration of these payments.

Other financial services may include an investment service and a mortgage service. The investment service allows users to manage their investment portfolios by scheduling transfers to and from their investment accounts. For example, users can set up automatic monthly transfers from their checking account to their investment account, ensuring consistent contributions to their retirement fund or other investment vehicles. The mortgage service allows users to manage their mortgage payments efficiently. Users may also schedule transfers between their different accounts. For instance, users can set up automatic transfers from their primary checking account to a savings account or allocate funds for specific purposes, such as a vacation or emergency fund.

Throughout this disclosure the use of the term “scheduled transaction” or “scheduled transfer” may refer to either a transfer between two accounts or a scheduled bill payment through a bill pay service.

Application server 102 is illustrated as separate elements (e.g., components). However, the functionality of multiple individual elements may be performed by a single element. An element may represent computer program code executable by processing system 112. The program code may be stored on a storage device (e.g., data store 116) and loaded into the memory of the processing system 112 for execution. Portions of the program code may be executed in parallel across multiple processing units. A processing unit may be a grouping of one or more cores of a general-purpose computer processor, a graphical processing unit, an application-specific integrated circuit, or a tensor processing core. Furthermore, the grouping may operate on a single device or multiple devices (either collocated or geographically dispersed). Accordingly, code execution using a processing unit may be performed on a single device or distributed across multiple devices. In some examples, using shared computing infrastructure, the program code may be executed on a cloud platform (e.g., MICROSOFT AZURE® and AMAZON EC2®).

Client device 104 may be a computing device which may be, but is not limited to, a smartphone, tablet, laptop, multi-processor system, microprocessor-based or programmable consumer electronics, game console, set-top box, or other device that a user utilizes to communicate over a network. In various examples, a computing device includes a display module (not shown) to display information (e.g., specially configured user interfaces). In some embodiments, computing devices may comprise one or more of a touch screen, camera, keyboard, microphone, or Global Positioning System (GPS) device.

Client device 104 and application server 102 may communicate via a network (not shown). The network may include local-area networks (LAN), wide-area networks (WAN), wireless networks (e.g., 802.11 or cellular network), Public Switched Telephone Network (PSTN), ad hoc networks, cellular, personal area networks or peer-to-peer (e.g., Bluetooth®, Wi-Fi Direct), or other combinations or permutations of network protocols and network types. The network may include a single Local Area Network (LAN), Wide-Area Network (WAN), or combinations of LANs or WANs, such as the Internet.

In some examples, the communication may occur using an application programming interface (API) such as API 114. An API provides a method for computing processes to exchange data. A web-based API (e.g., API 114) may permit communications between two or more computing devices, such as a client and a server. The API may define a set of HTTP calls according to Representational State Transfer (RESTful) practices. A RESTful API may define various GET, PUT, POST, and DELETE methods to create, replace, update, and delete data stored in a database (e.g., data store 116). For example, a web page may be presented to web client 106 from web server 108. The data presented on the webpage may include data received based on an API call. In another example, a user may use the webpage to create a scheduled transaction event (e.g., between a first account and a second account). The transaction details of the transaction may be transmitted to the application server 102 via API 114. APIs may also be used between computing processes. For example, an API call may be defined to retrieve transaction details for a scheduled transaction. Or an API call may be defined to initiate an analysis of a user account (e.g., using transaction analysis logic 120).

User accounts 118 may include user profiles on users of application server 102. A user profile may include credential information such as a username and hash of a password or a passkey (e.g., access token). A user may enter their username and plaintext password on a login page of application server 102 to view their user profile information or interfaces presented by application server 102 in various examples. A user account may be associated with a user account identifier. A user account may also be associated with one or more secondary accounts. A secondary account may have an account type such as, but not limited to, savings, checking, retirement, and mortgage. Each secondary account may have its own account identifier, which may be associated with the user account identifier.

“Associated” in the context of linking an account to a user profile (or other data linkages described herein) may be implemented differently depending on the underlying database system. For example, in a relational database management system (RDBMS), “associated” may refer to the relationship between tables. The relationship could be one-to-one, one-to-many, or many-to-many, established through foreign key constraints. For example, in a one-to-many relationship, a record in Table A (e.g., a user account table) may be associated with multiple records in Table B (e.g., a secondary accounts table), using a foreign key in Table B that references the primary key in Table A.

Application server 102 may include web server 108 to enable data exchanges with client device 104 via web client 106. Although generally discussed in the context of delivering webpages via the Hypertext Transfer Protocol (HTTP), other network protocols may be utilized by web server 108 (e.g., File Transfer Protocol, Telnet, Secure Shell, etc.). A user may enter a uniform resource identifier (URI) into web client 106 (e.g., the INTERNET EXPLORER® web browser by Microsoft Corporation or SAFARI® web browser by Apple Inc.) that corresponds to the logical location (e.g., an Internet Protocol address) of web server 108. In response, web server 108 may transmit a web page rendered on a client device's display device (e.g., a mobile phone, desktop computer, etc.).

Additionally, web server 108 may enable users to interact with one or more web applications provided in a transmitted web page. A web application may provide user interface (UI) components rendered on a display device of the client device 104. The user may interact (e.g., select, move, enter text into) with the UI components, and, based on the interaction, the web application may update one or more portions of the web page. A web application may be executed in whole or in part locally on client device 104. The web application may populate the UI components with data from external or internal sources (e.g., data store 116) in various examples.

The web application may be a dynamic user interface configured to provide transaction management services to users. For example, users may log in using their credentials (e.g., a username and password or token). The web application may present user interface elements configured to create, modify, or delete scheduled transfers or payments. Additionally, the user interface may present results of analyzing a user's accounts as discussed for transaction analysis logic 120.

The web application may be executed according to application logic 110. Application logic 110 may use the various elements of application server 102 to implement the web application. For example, application logic 110 may issue API calls to retrieve or store data from data store 116 and transmit it for display on client device 104. Similarly, data entered by a user into a UI component may be transmitted using API 114 back to the web server. Application logic 110 may use other elements (e.g., transaction analysis logic 120, message streaming system 122, etc.) of application server 102 to perform functionality associated with the web application as described further herein.

Data store 116 may store data that is used by application server 102. Data store 116 is depicted as a singular element but may be multiple data stores. The data store 116 may include several databases of varying model architectures such as, but not limited to, a relational database (e.g., SQL), a non-relational database (NoSQL), a flat-file database, an object model, a document details model, graph database, shared ledger (e.g., blockchain), or a file system hierarchy. Data store 116 may store data on one or more storage devices (e.g., a hard disk, random access memory (RAM), etc.). The storage devices may be in standalone arrays, part of one or more servers, and located in one or more geographic areas.

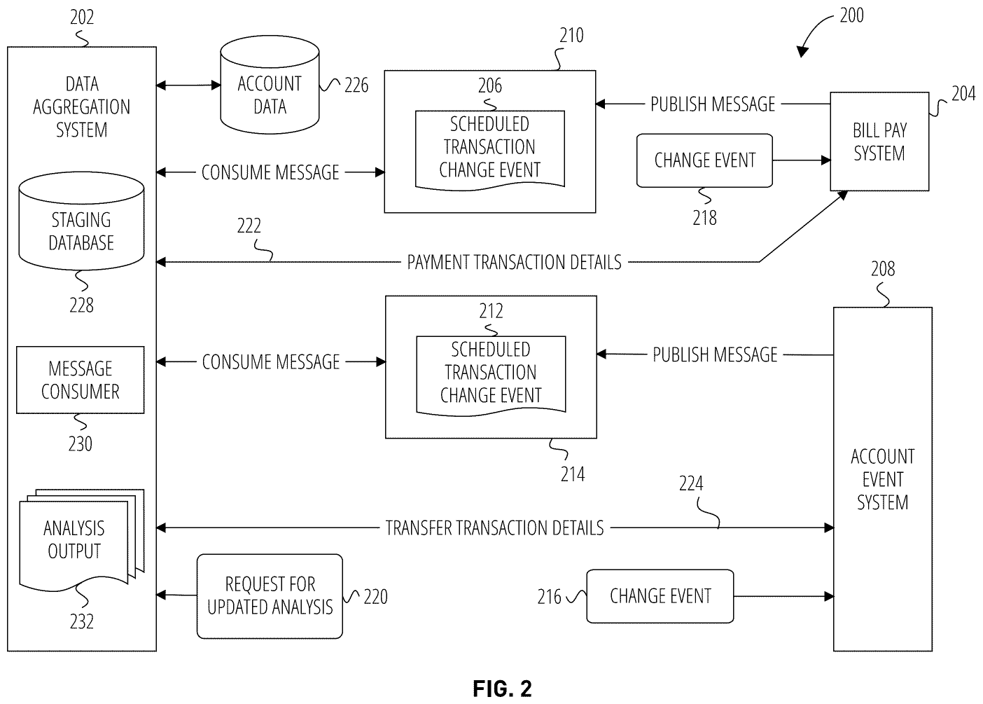

Data structures may be implemented in several ways depending on the programming language of an application or the database management system used by an application. For example, if C++ is used, the data structure may be implemented as a struct or class. In the context of a relational database, a data structure may be defined in a schema. Some of the data structures and database that may be part of data store 116 are discussed in the context of FIG. 2.

The transaction analysis logic 120 may analyze scheduled transactions, either transfers between accounts or payments in bill pay, to determine insights about future cash flow. This analysis begins with collecting data on scheduled transactions, including the amount, frequency, and timing of each transaction, as well as account data information (e.g., balances). The data may include bill payments, transfers to investment or savings accounts, mortgage payments, etc. Utilizing this collected data, the transaction analysis logic 120 may project future cash flows by comparing expected inflows, such as salary deposits, alongside outflows, such as scheduled payments and transfers, for a specified period (e.g., daily, weekly, monthly).

The transaction analysis logic 120 may forecast the balance of the user's accounts over the projected period considering the scheduled transactions and current account balances to predict end-of-period balances for each account. Based on the forecasted amounts, the transaction analysis logic 120 may generate insights, including but not limited to low balance alerts, such as “With your currently scheduled transactions, you will have a low balance in your checking account at the end of the month.” or “You are at risk of an overdraft in your checking account on the 15th due to a large scheduled bill payment.”

The transaction analysis logic 120 may also generate recommendations. In various examples, an insight analysis differs from a recommendation analysis, although they may be complementary. For example, some recommendations may be “Consider saving $50 every month into a vacation fund to achieve your travel goals without straining your budget” or “Increase your monthly savings to your emergency fund by $20 to ensure you have adequate coverage for unexpected expenses.” It may also suggest spending adjustments to prevent low balances or overdrafts, such as “Reduce your discretionary spending by $30 per week to avoid a low balance in your checking account at the end of the month.” Consequently, a recommendation includes a suggested action to take whereas an insight is informational with no suggested action.

The message streaming system 122 may be a message distribution architecture for publishing messages. The message streaming system 122 may facilitate real-time communication and data processing by categorizing messages based on their respective topics. When a message is published to message streaming system 122, it is tagged with a topic identifier, which serves as a descriptor of the message's content or purpose.

The architecture of the message streaming system 122 may include a message broker responsible for managing the distribution of messages to appropriate subscribing components or a data stream for the topic. Components that have an interest in certain types of messages may subscribe to the relevant topics through the message broker or read directly from the data stream for the topic.

In various examples, the message streaming system 122 may utilize APACHE KAFKA® as its underlying infrastructure. In such a configuration, the message broker functionality is managed by Kafka, which organizes messages into topics. Producers publish messages to Kafka topics, while consumers read from these topics to receive relevant messages. Consumers in Kafka poll the topics they are interested in, continuously checking for new messages.

FIG. 2 is a block diagram of a message production and consumption architecture system, according to various examples. Diagram 200 includes a data aggregation system 202 with a staging database 228, message consumer 230, analysis output 232, electronic message 210 with topic 206, electronic message 214 with topic 212, bill pay system 204 receiving change event 218, account event system 208 receiving change event 216, a request for updated analysis 220, transaction details 222, and transaction details 224. The arrangement in diagram 200 may represent an example implementation of an event-oriented architecture to reduce the volume and impact of API calls as initially discussed. For example, the implementation may be used by a server such as application server 102 of FIG. 1. Although bill pay system 204 and account event system 208 are depicted as separate systems, a single system may be used to manage both. Furthermore, a shared database may store scheduled transaction information for bill payments and account-type transfers.

Beginning on the right-hand side of diagram 200, bill pay system 204 and account event system 208 may represent logic and storage for scheduled transactions associated with users.

For example, bill pay system 204 may store scheduled transaction entries in a database having columns for a transaction identifier, a bill payee (e.g., an identifier of the person/entity receiving money), a payor account (e.g., a checking account identifier), an amount, a payment date, a payment status (e.g., scheduled, paid, canceled), and a user account identifier. More or fewer columns may be used without departing from the scope of this disclosure.

Similarly, account event system 208 may store entries in a database having columns for a transaction identifier, a transferee account (e.g., an account identifier that is receiving funds), a transferor account (e.g., a checking account identifier), an amount, a scheduled date, a transfer status (e.g., scheduled, transferred, canceled), and a user account identifier. More or fewer columns may be used without departing from the scope of this disclosure. More or fewer columns may be used without departing from the scope of this disclosure.

Change event 218 and change event 216 represent changes to transactions for bill pay system 204 and account event system 208, respectively. When a change event is received, a transaction database may be updated. For example, if an RDBMS is used, a structured query language command may be issued to change an existing value of a transaction or create a new transaction. The change event may be received via an API (such as API 114) or based on consuming a message on a message streaming system (e.g., message streaming system 122).

A change event may be triggered in several ways and may originate from a user action or system action. User-initiated changes of account event system 208 may involve modifications to the details of existing transactions or the setup of new transaction parameters via provided user interfaces in a web page or mobile app. For instance, a user may change the source account for a recurring transfer, such as switching from a checking to a savings account. A user might also adjust the amount or frequency of a recurring transfer, such as increasing the amount transferred into a savings account as part of a new savings goal.

A system action may generate change event 218 when a new bill is received for the upcoming month. Accordingly, a change event may create a new transaction with the payment amount or update the payment date to align with the new billing cycle. Another type of system action may be a change in the state of an existing transaction. For example, a transfer transaction (e.g., to transfer money to a brokerage account from a checking account) may have its status changed from pending to completed.

Suppose bill pay system 204 or account event system 208 changes a future event for a user account (which may include deleting an existing transaction or creating a new transaction). In such a case, a message may be published on a message streaming system. As an example, consider that there is a currently scheduled transaction to pay an electric utility bill for a user account in bill pay system 204. The user associated with the user account may decide to change a payment source for the bill. Upon making the change, bill pay system 204 may update the transaction entry associated with the electric utility bill of the user account.

Additionally, a monitoring component of bill pay system 204 or account event system 208 may detect the scheduled transaction change for the user account. For example, the monitoring component may receive a message from a RDBMS that an entry was updated. In response, bill pay system 204 may generate electronic message 210, or account event system 208 may generate electronic message 214 according to the schema of a message streaming system (e.g., message streaming system 122).

The schema may include fields for a topic (e.g., topic 206 or topic 212) of the message and payload. For example, the payload may include a user account identifier associated with the change. The topic may be “scheduled transaction change event” or more granular, such as “scheduled bill pay transaction change event.” Additionally, the payload in electronic message 210 may be more detailed. For example, there may be a field for a transaction identifier corresponding to an entry in a transaction database and the type of change event (e.g., new transaction, canceled transaction, status update, amount update, change in date, change in transfer amount, etc.).

Electronic message 210 and electronic message 214 may be published to a message streaming system. For example, if KAFKA® is used, the messages may be generated by a message producer component and sent (e.g., published) to a broker. The broker may determine one or more partitions (e.g., distributed storage locations) to send the message. However, other message systems may be used as discussed in FIG. 1.

The data aggregation system 202 may include a message consumer 230 to process electronic messages published on a message streaming system. For example, message consumer 230 may process data streams corresponding to the “scheduled transaction change event” topic. In another example, a server may maintain a list of devices/entities that are subscribed to certain topics. Accordingly, if message consumer 230 is subscribed to the “scheduled transaction change” topic, the server may push electronic message 210 and electronic message 214 to message consumer 230. In either implementation, the message consumer 230 does not need to actively check for the changes from bill pay system 204 or account event system 208.

Upon receiving an electronic message, the data aggregation system 202 may parse (e.g., using the message streaming system schema) the payload. The payload may be the data beyond the topic identifier of the electronic message. For example, it may include a user account identifier associated with the change and a transaction identifier. The payload may also identify which system the scheduled transaction change event originated from (e.g., a brokerage system of account event system 208 or bill pay system 204).

The data aggregation system 202 may access transaction details of the scheduled transaction change for a future event based on the received electronic message. For example, for electronic message 210, the data aggregation system 202 may generate and execute an API call to bill pay system 204 for transaction details 222 using the user account identifier and transaction identifier as a parameter of the API call. The transaction details 222 may include more detailed information than the data electronic message 210 such as the bill amount, the account from which the bill amount will be pulled, the date of the payment, and the payment status.

Similarly, for electronic message 214, the data aggregation system 202 may generate and execute a call for transaction details 224 from account event system 208. If a specific subsystem of the account event system 208 is identified (either as part of the topic identifier or in the payload), the API call may be issued directly to that subsystem. The transaction details 224 may include a transferor account, a transferee account, an amount, a transfer date, a transfer status, etc.

In various examples, the requested transaction details are not limited to a specific transaction. For example, the API call may request details on all currently scheduled transactions for the user account identifier. The data received in response to the API calls (either for a specific transaction or many) may be stored in the staging database 228.

The staging database 228 may include data used to generate an analysis of a user's account, such as one or more insights. The analysis may be performed using a component such as transaction analysis logic 120 of FIG. 1. For example, in addition to transaction details, the staging database 228 may store data from account data 226. The account data 226 may include balance information of the user's secondary accounts (e.g., checking, savings). The staging database 228 may also store generated analyses (e.g., analysis output 232).

In addition to storing transaction details, the data aggregation system 202 may flag a user account identifier as having a change when receiving an electronic message. For example, within the staging database 228, there may be a user account table that indicates the last time an analysis was performed. Once an electronic message with a scheduled transaction change event topic is received, the entry associated with the user account identifier of the electronic message may be updated to indicate (e.g., change a Boolean value) that the current analysis is out-of-date.

The data aggregation system 202 may receive a request for updated analysis 220. This request may be triggered by a login event associated with a user account identifier or a scheduled update event (e.g., nightly at 2 AM). The request for updated analysis 220 may be for one user account or multiple accounts. For example, a nightly update may be performed. However, as indicated previously, one of the problems with the mass updating of accounts is the wasted computing resources of issuing API calls for each account even if there have been no changes in future events (e.g., scheduled transactions). Consequently, by using a flag and already having the data needed for analysis in the staging database 228, unnecessary API calls and analysis computation may be avoided.

Thus, when the request for updated analysis 220 a check may be made to determine if the flag for a user account identifier has been set as having new data. If the flag is not set, the data aggregation system 202 may not generate a new analysis. If the flag is set, a new analysis may be generated of a future state of the user account (e.g., an insight) based in part on the data in the staging database. The analysis may be stored as analysis output 232 and associated with a user account identifier. Furthermore, the flag may be removed so a subsequent request for updated analysis 220 would not result in duplicating the analysis.

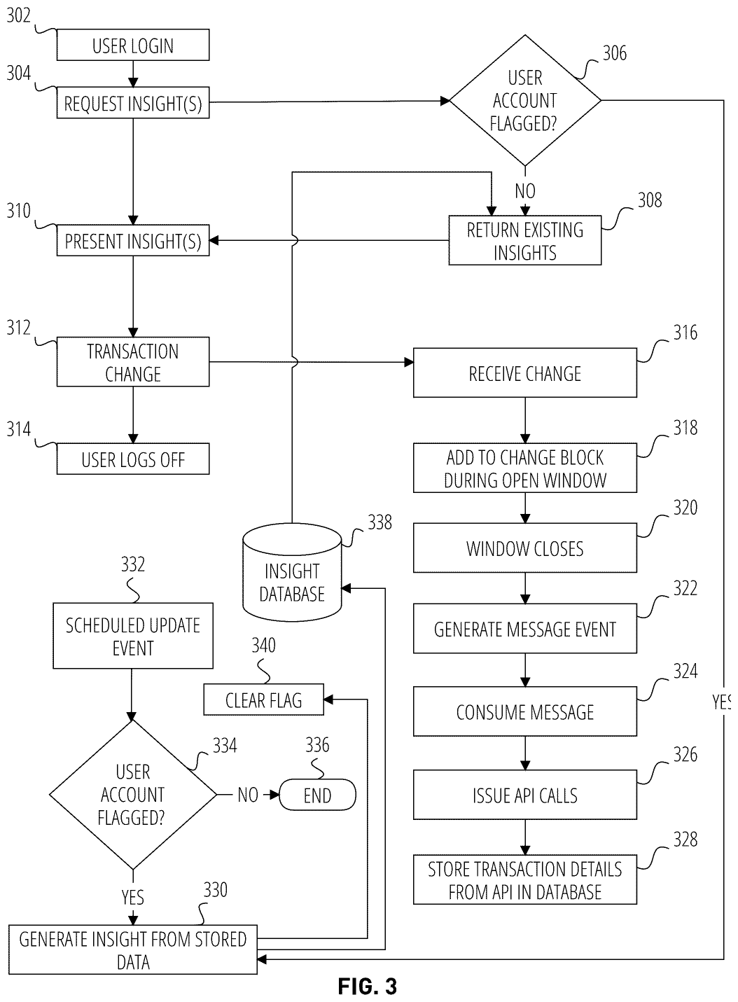

FIG. 3 is a block diagram of operations in an event-oriented architecture, according to various examples. The operations may describe a method of generating insights based on events. The method may be implemented using the systems described in FIG. 1 and FIG. 2. For example, the application server 102 may host a web page that a user has logged into, and application logic 110, transaction analysis logic 120, and message streaming system 122 may process the interactions with the user. Additionally, the architecture of the events and analysis may be one such as described in FIG. 2

The method may be embodied in a set of instructions stored in at least one computer-readable storage device of a computing device. A computer-readable storage device excludes transitory signals. In contrast, a signal-bearing medium may include such transitory signals. A machine-readable medium may be a computer-readable storage device or a signal-bearing medium. A processing unit, which, when executing the set of instructions, may configure the processing unit to perform the operations illustrated in FIG. 3. The processing unit may instruct other components of a computing device to carry out the set of instructions. For example, the processing unit may instruct a network device to transmit data to another computing device, or the computing device may provide data over a display interface to present a user interface. In some examples, the method's performance may be split across multiple computing devices using a shared computing infrastructure (e.g., the processing unit encompasses multiple distributed computing devices).

The operations of FIG. 3 describe a scenario in which a user may log in to their account using a computing device and change a scheduled transaction for a future event (e.g., a transfer). The diagram begins with operation 302, in which users enter their credentials to a web page or mobile application. The user may have a user account identifier associated with a user account stored in an account database, such as described for user accounts 118.

Receiving a login event associated with a user account identifier may trigger a request for updated insights (e.g., operation 304) or other analysis associated with the user account identifier. At decision operation 306, it is determined if the user account identifier has a flag in a database indicating new data has been retrieved that would necessitate an updated analysis be performed. If the result of checking for the flag (e.g., a query to a database) indicates there is no flag, operation 308 may executed.

At operation 308, insights (e.g., analysis results with an insight type) associated with the user account identifier may be presented (e.g., operation 310) on the computing device. Because there is no flag set, existing insights may be retrieved from insight database 338 for the user account identifier without further analysis. Presenting may include transmitting the insights to the computing device and having them rendered on the computing device.

The user may then decide to make a scheduled transaction change for a future event (e.g., operation 312) and log off (e.g., operation 314). For example, the future event may be a bill pay or recurring transfer between accounts. The scheduled transaction change may be a change in the amount due for a payee or a change in the date or transfer amount of the future event for the recurring transfer. The scheduled transaction change may be made using a presented user interface of the computing device.

At operation 316, the scheduled transaction change for the future event may be detected (e.g., received at application server 102) and processed. For example, detecting may include receiving, via a computing device associated with the user account, the scheduled transaction change.

To reduce the number of electronic messages generated (e.g., operation 322) and corresponding API calls made, a message window may be used with an open time period. During the time period the window is open, indications a scheduled transaction change was detected may be stored, such as by adding the indication to a change block, such as a list data structure (e.g., operation 318). The indication may include a user account identifier. For example, a user may make multiple changes for multiple future events in a relatively short period of time (e.g., five minutes). However, multiple API calls would be issued if an electronic message was generated and published each time a change was detected. Accordingly, the electronic message may be delayed from being published until determining the message window time period has lapsed (operation 320).

Once the window closes (e.g., the time period has lapsed), an electronic message may be generated (e.g., operation 322) and published to a messaging streaming system according to the schema of a message streaming system as described previously. If multiple changes were made during the window the message payload may identify the source of the change. For example, if a user made a bill pay change and a change to a mortgage payment, the payload may identify a “bill pay” and “mortgage accounts.” Another implementation may be to issue an electronic message for each system. Consequently, when the electronic message is consumed (e.g., operation 324), API calls may be issued to retrieve transaction details from the identified systems.

In various examples, a single indication is stored for each detected scheduled transaction change per user identifier. Accordingly, if a second scheduled transaction change is detected during the same open window, a subsequent indication may not be stored. In other examples, indications may be stored for each detected change. Thus, a change block during the open window of time may be a collection of user account identifiers that have had scheduled transaction changes detected during the open window.

After the window closes, electronic messages may be generated and published. However, a single electronic message may be generated with a topic identifier and user account identifier even if multiple changes were detected for the user account identifier. Additionally, at the end of the message window time, the existing indications of user account identifiers in the change block may be removed and a new window be opened. Although not illustrated, a message streaming system (e.g., such as message streaming system 122) may receive the generated electronic messages and route electronic messages to a topic stream associated with the topic identifier as discussed previously.

At operation 324, a data aggregation system may be configured to (e.g., subscribe to) read from the topic stream and “consume” the published electronic messages. The data aggregation system may process the electronic messages as discussed in FIG. 2 for data aggregation system 202. For example, the data aggregation system may parse a payload of the electronic message to retrieve a user account identifier and access transaction details of the scheduled transaction change for the future event.

The transaction details may be accessed by querying, using an application programming interface (API), a transaction database for the transaction details of the scheduled transaction change for the future event (e.g., operation 326). In various examples, the transaction details may be retrieved from the payload of the electronic messages. In either case, at operation 328, the transaction details may be stored in the staging database (e.g., staging database 228). Furthermore, a flag be set for the user account identifier in the staging database 228, which indicates a new analysis should be performed for the user account identifier.

In various examples, receiving a request to update an analysis of the user account may be triggered by a scheduled update event (e.g., 332), such as nightly. The scheduled update event may be a batch process that checks all user account identifiers to determine if a new analysis is needed. At decision operation 334, it may be determined if a user account identifier has been flagged such as described for decision operation 306. If the user account identifier is not flagged, no further action may be needed (e.g., end 336).

However, if the user account identifier has been flagged, an analysis of a future state of the user account may be generated (e.g., 330) based in part on the data in the staging database, such as by using transaction analysis logic 120. The resulting analysis may be stored as associated with the user account identifier in insight database 338, according to various examples. At operation 340, after the analysis has been generated, the flag may be cleared for the user account identifier.

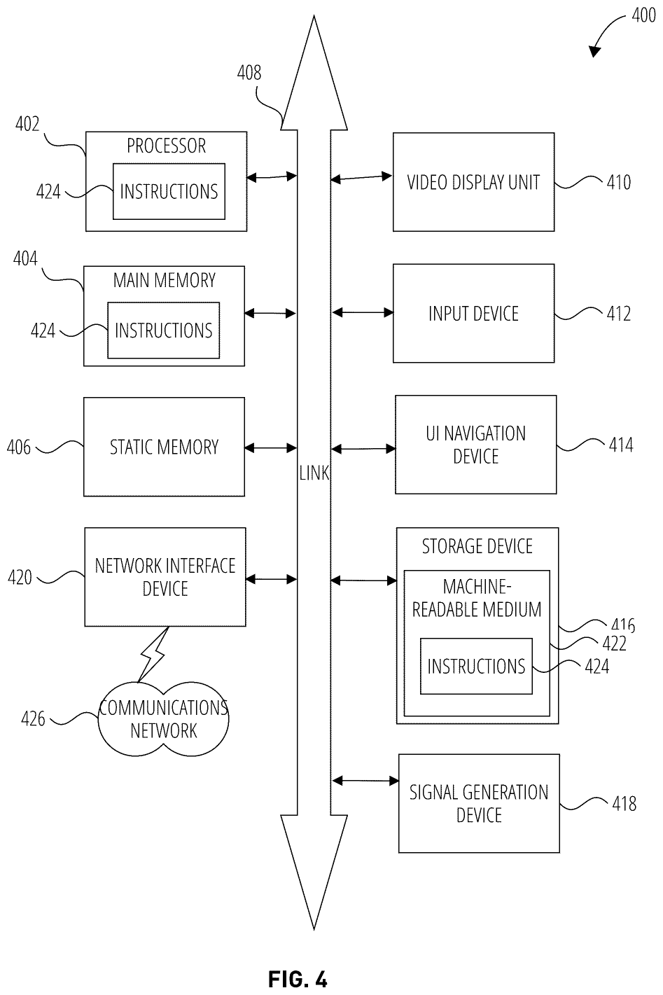

FIG. 4 is a block diagram illustrating a machine in the example form of computer system 400, within which a set or sequence of instructions may be executed to cause the machine to perform any of the methodologies discussed herein, according to an example embodiment. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) Network environments. The machine may be an onboard vehicle system, wearable device, personal computer (PC), tablet PC, hybrid tablet, personal digital assistant (PDA), mobile telephone, or any machine capable of executing instructions (sequential or otherwise) that specify actions to be taken by that machine. Further, while only a single machine is illustrated, the term “machine” includes any collection of machines that individually or jointly execute a set (or multiple sets) of instructions to perform any of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein

Example computer system 400 includes at least one processor 402 (e.g., a central processing unit (CPU), a graphics processing unit (GPU) or both, processor cores, compute nodes, etc.), a main memory 404, and a static memory 406, which communicate with each other via a link 408. The computer system 400 may include a video display unit 410, an input device 412 (e.g., a keyboard), and a user interface UI navigation device 414 (e.g., a mouse). In an example, the video display unit 410, input device 412, and UI navigation device 414 are incorporated into a single device housing, such as a touchscreen display. The computer system 400 may additionally include a storage device 416 (e.g., a drive unit), a signal generation device 418 (e.g., a speaker), a network interface device 420, and one or more sensors (not shown), such as a global positioning system (GPS) sensor, compass, accelerometer, or other sensors.

The storage device 416 includes a machine-readable medium 422 on which one or more sets of data structures and instructions 424 (e.g., software) embodying or utilized by any of the methodologies or functions described herein. The instructions 424 may also reside, completely or at least partially, within the main memory 404, the static memory 406, or within the processor 402 during execution thereof by the computer system 400, with the main memory 404, the static memory 406, and the processor 402 also constituting machine-readable media.

While the machine-readable medium 422 is illustrated in an example embodiment to be a single medium, the term “machine-readable medium” may include a single medium or multiple media (e.g., a centralized or distributed database or associated caches and servers) that store the instructions 424. The term “machine-readable medium” shall also be taken to include any tangible medium that is capable of storing, encoding, or carrying instructions for execution by the machine and that causes the machine to perform any one or more of the methodologies of the present disclosure or that is capable of storing, encoding or carrying data structures utilized by or associated with such instructions. The term “machine-readable medium” includes, but is not limited to, solid-state memories and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks. A computer-readable storage device may be a machine-readable medium 422 that excludes transitory signals.

The instructions 424 may be transmitted or received over a communications network 426 using a transmission medium via the network interface device 420 utilizing a transfer protocol (e.g., HTTP). Examples of communication networks include a local area network (LAN), a wide area network (WAN), the Internet, mobile telephone networks, plain old telephone (POTS) networks, and wireless data networks (e.g., Wi-Fi, 3G, and 4G LTE/LTE-A or WiMAX networks). The term “transmission medium” shall be taken to include any intangible medium that is capable of storing, encoding, or carrying instructions for execution by the machine and includes digital or analog communications signals or other intangible mediums to facilitate communication of such software.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplate are examples using any combination or permutation of those elements shown or described (or one or more aspects thereof), either with respect to a particular example (or one or more aspects thereof), or with respect to other examples (or one or more aspects thereof) shown or described herein.

What is claimed is:

1. A method comprising:
detecting, using a processing unit, a scheduled transaction change for a future event with respect to a user account, the user account associated with a user account identifier;
generating an electronic message according to a schema of a message streaming system, the electronic message including a topic identifier and the user account identifier;
publishing the electronic message to the message streaming system;
processing, at a data aggregation system, the electronic message from the message streaming system, wherein processing includes:
parsing a payload of the electronic message to retrieve the user account identifier;
accessing transaction details of the scheduled transaction change for the future event; and
storing the transaction details in a staging database;
receiving a request to update an analysis of the user account;
in response to the request, generating an analysis of a future state of the user account based in part on the data in the staging database; and
storing the analysis as associated with the user account identifier.

2. The method of claim 1, wherein detecting, using the processing unit, the scheduled transaction change event with respect to the user account includes:
receiving, via a computing device associated with the user account, the scheduled transaction change.

3. The method of claim 2, wherein the scheduled transaction change identifies a change in date of the future event.

4. The method of claim 2, wherein the scheduled transaction change identifies a change in a transfer amount of the future event.

5. The method of claim 1, further comprising:
at the message streaming system, routing the electronic message to a topic stream associated with the topic identifier and wherein the data aggregation system is configured to read message from the topic stream.

6. The method of claim 1, wherein receiving the request to update an analysis of the user account is triggered by a scheduled update event.

7. The method of claim 1, wherein receiving the request to update an analysis of the user account is triggered by a login event associated with the user account identifier.

8. The method of claim 1, further comprising, prior to publishing the electronic message to the message streaming system;
storing an indication the scheduled transaction change was detected;
determining a message window time period has lapsed; and
in response to the determining:
publishing the electronic message; and
removing the indication.

9. The method of claim 1, wherein accessing transaction details of the scheduled transaction change for the future event comprises:
querying, using an application programming interface (API), a transaction database for the transaction details of the scheduled transaction change for the future event.

10. The method of claim 1, wherein accessing transaction details of the scheduled transaction change for the future event comprises:
retrieving the transaction details of the scheduled transaction change for the future event from the payload of the electronic message.

11. A non-transitory computer-readable medium comprising instructions, which when executed by a processing unit, configure the processing unit to perform operations comprising:
detecting a scheduled transaction change for a future event with respect to a user account, the user account associated with a user account identifier;
generating an electronic message according to a schema of a message streaming system, the electronic message including a topic identifier and the user account identifier;
publishing the electronic message to the message streaming system;
processing, at a data aggregation system, the electronic message from the message streaming system, wherein processing includes:
parsing a payload of the electronic message to retrieve the user account identifier;
accessing transaction details of the scheduled transaction change for the future event; and
storing the transaction details in a staging database;
receiving a request to update an analysis of the user account;
in response to the request, generating an analysis of a future state of the user account based in part on the data in the staging database; and
storing the analysis as associated with the user account identifier.

12. The non-transitory computer-readable medium of claim 11, wherein detecting, using the processing unit, the scheduled transaction change event with respect to the user account includes:
receiving, via a computing device associated with the user account, the scheduled transaction change.

13. The non-transitory computer-readable medium of claim 12, wherein the scheduled transaction change identifies a change in date of the future event.

14. The non-transitory computer-readable medium of claim 12, wherein the scheduled transaction change identifies a change in a transfer amount of the future event.

15. The non-transitory computer-readable medium of claim 11, wherein the instructions, which when executed by the processing unit, further configure the processing unit to perform operations comprising:
at the message streaming system, routing the electronic message to a topic stream associated with the topic identifier and wherein the data aggregation system is configured to read message from the topic stream.

16. The non-transitory computer-readable medium of claim 11, wherein receiving the request to update an analysis of the user account is triggered by a scheduled update event.

17. The non-transitory computer-readable medium of claim 11, wherein receiving the request to update an analysis of the user account is triggered by a login event associated with the user account identifier.

18. The non-transitory computer-readable medium of claim 11, wherein the instructions, which when executed by the processing unit, further configure the processing unit to perform, prior to publishing the electronic message to the message streaming system, operations comprising;
storing an indication the scheduled transaction change was detected;
determining a message window time period has lapsed; and
in response to the determining:
publishing the electronic message; and
removing the indication.

19. A system comprising:
a processing unit; and
a storage device comprising instructions, which when executed by the processing unit, configure the processing unit to perform operations comprising:
detecting a scheduled transaction change for a future event with respect to a user account, the user account associated with a user account identifier;
generating an electronic message according to a schema of a message streaming system, the electronic message including a topic identifier and the user account identifier;
publishing the electronic message to the message streaming system;
processing, at a data aggregation system, the electronic message from the message streaming system, wherein processing includes:
parsing a payload of the electronic message to retrieve the user account identifier;
accessing transaction details of the scheduled transaction change for the future event; and
storing the transaction details in a staging database;
receiving a request to update an analysis of the user account;
in response to the request, generating an analysis of a future state of the user account based in part on the data in the staging database; and
storing the analysis as associated with the user account identifier.

20. The system of claim 19, wherein the instructions, which when executed by the processing unit, further configure the processing unit to perform, prior to publishing the electronic message to the message streaming system, operations comprising;
storing an indication the scheduled transaction change was detected;
determining a message window time period has lapsed; and
in response to the determining:
publishing the electronic message; and
removing the indication.
